(19) United States
(12) Patent Application Publication
(10) Pub. No.: US 2019/0130693 A1
(43) Pub. Date: May 2, 2019

(54) Bulk Material Dispensing System and Method

(71) Applicant: MAIZE KRAIZE, LLC, GUIN, AL (US)

(72) Inventors: Jason L. SPILLER, GUIN, AL (US); Benjamin E. BURLESON, GUIN, AL (US)

(21) Appl. No.: 16/173,192

(22) Filed: Oct. 29, 2018

Related U.S. Application Data
(60) Provisional application No. 62/707,337, filed on Oct. 30, 2017.

(51) Int. Cl. G07F 13/06; G07F 13/04; G07F 13/10; B65G 3/04; B65G 11/02; B65G 11/08; B65G 11/18

(52) U.S. Cl. CPC G07F 13/06; G07F 13/04; G07F 13/10; B65G 11/106; B65G 11/026; B65G 11/083; B65G 11/186; B65G 3/04

(57) ABSTRACT

A bulk material dispensing system including a dispensing apparatus suspended from a fixed surface that is configured to receive bulk material from a tank. A metering device feeds the bulk material from the tank to the dispensing apparatus, and a weigh scale is located between the dispensing apparatus and the fixed surface. A controller is in communication with each of the weigh scale and the metering device such that, based on a signal received from the weigh scale that is indicative of the amount of the bulk material that has been fed to the dispensing apparatus by the metering device, the controller controls a rate at which the metering device feeds the bulk material to the dispensing apparatus to ensure that an accurate amount of the bulk material is received by the dispensing apparatus.

### CROSS-REFERENCE TO RELATED APPLICATIONS

This application claims the benefit of U.S. Provisional Application No. 62/707,337 filed on Oct. 30, 2017. The entire disclosure of the above application is incorporated herein by reference.

### FIELD

The present disclosure relates to a bulk material dispensing apparatus and method.

### BACKGROUND

This section provides background information related to the present disclosure which is not necessarily prior art.

Vending machines are well known, and may be used for dispensing a variety of products. For example, various vending machines may dispense money, drinks, snacks, tickets, electronics, propane refill tanks, toys, DVD movies, and a number of other products. The products dispensed by these vending machines, however, must be separately packaged and/or separated so that the products can be easily dispensed, and so that consumer can easily select a desired item and receive the desired selection accordingly.

Inasmuch as vending machines typically dispense separately packaged and/or separated products, wet and/or dry bulk materials are not typically dispensed by a vending machine delivery system unless the bulk materials are pre-measured into a pre-selected quantity and packaged accordingly. For example, to dispense bulk materials such as grains or sand, the bulk material must be pre-packaged into discreet quantities in order to be dispensed by a vending machine. Other examples of pre-packaged bulk materials include a bundle of firewood, a bag of mulch, a bag of rock salt, a bag of decorative gravel, a sack of corn, a sack of pet food, and the like. As a result, a significant shortcoming of the conventional bulk material delivery systems includes that the bulk materials are not available through a delivery system that is able to accurately meter an incremental quantity of the bulk material and subsequently dispense the bulk materials.

Yet another shortcoming of conventional bulk material delivery systems includes that there is no provision for dispensing accurate quantities of bulk materials that can be a combination of wet and/or dry bulk materials.

### SUMMARY

This section provides a general summary of the disclosure, and is not a comprehensive disclosure of its full scope or all of its features.

According to a first aspect of the present disclosure, provided is a bulk material dispensing system including a first tank configured to carry a first bulk material; a first dispensing apparatus suspended from a fixed surface, and configured to receive the first bulk material from the first tank and dispense the first bulk material; a first conveying system positioned between the first tank and the first dispensing apparatus, and including a first metering device for feeding the first bulk material from the first tank to the first dispensing apparatus; a first weigh scale located between the first dispensing apparatus and the fixed surface, and configured to communicate a signal indicative of an amount of the first bulk material that has been fed to the first dispensing apparatus by the first metering device; and a controller in communication with each of the first weigh scale and the first metering device and, based on the signal indicative of the amount of the first bulk material that has been fed to the first dispensing apparatus by the first metering device, is configured to control a rate at which the first metering device feeds the first bulk material to the first dispensing apparatus to ensure that an accurate amount of the first bulk material is received by the first dispensing apparatus.

The first tank may include a sensor in communication with the controller, wherein the sensor is configured to communicate a signal indicative of an amount of the first bulk material present in the first tank.

The first dispensing apparatus may include a hopper suspended by a plurality of cables from the fixed surface, wherein each of the cables are attached to the fixed surface at a single location.

The hopper may include a movable door that is either manually actuatable, or is in communication with the controller such that when the hopper has received the accurate amount of the first bulk material, the controller actuates the movable door to an open position to dispense the first bulk material.

The hopper may also include a chute for dispensing the first bulk material.

The first conveying system may include one or a combination of a vibratory system, an injection system, and a conveyor belt system.

The first metering device may include a precision auger having a precise programmed variable rotation control that is controlled by the controller to control a rate at which the metering device feeds the first bulk material to the first dispensing apparatus. With such a configuration, the first bulk material may be a dry bulk material.

Alternatively, the first metering device may be a precision pump having a precise programmed variable pumping control that is controlled by the controller to control a rate at which the first metering device feeds the first bulk material to the first dispensing apparatus. With such a configuration, the first bulk material may be a wet bulk material.

According to a second aspect of the present disclosure, the bulk material dispensing system may further include a second conveying system positioned between the first tank and the first dispensing apparatus that includes a second metering device for feeding the first bulk material from the first tank to the first dispensing apparatus, wherein the controller is in communication with the second metering device, and based on the signal indicative of the amount of the first bulk material that has been fed to the first dispensing apparatus by the first metering device and the second metering device, is configured to control a rate at which the first metering device and the second metering device feeds the first bulk material to the first dispensing apparatus to ensure that an accurate amount of the first bulk material is received by the first dispensing apparatus.

According to a third aspect of the present disclosure, the bulk material dispensing system may include a second dispensing apparatus suspended from the fixed surface that is configured to receive the first bulk material from the first tank and dispense the first bulk material; a second conveying system positioned between the first tank and the second dispensing apparatus that includes a second metering device for feeding the first bulk material from the first tank to the second dispensing apparatus; and a second weigh scale located between the second dispensing apparatus and the fixed surface that is configured to communicate a signal indicative of an amount of the first bulk material that has been fed to the second dispensing apparatus by the second metering device, wherein the controller is in communication with each of the second weigh scale and the second metering device and, based on the signal indicative of the amount of the first bulk material that has been fed to the second dispensing apparatus by the second metering device, is configured to control a rate at which the second metering device feeds the first bulk material to the second dispensing apparatus to ensure that an accurate amount of the first bulk material is received by the second dispensing apparatus.

According to a fourth aspect of the present disclosure, the bulk material dispensing system may also include a second tank configured to carry a second bulk material; and a second conveying system positioned between the second tank and the first dispensing apparatus, wherein a second metering device feeds the second bulk material from the second tank to the first dispensing apparatus; wherein the first weigh scale is configured to communicate a signal indicative of a combined amount of the first bulk material and the second bulk material that has been fed to the first dispensing apparatus by the metering device; and wherein the controller is in communication with each of the first weigh scale and the second metering device and, based on the signal indicative of the combined amount of the second bulk material that has been fed to the first dispensing apparatus by the second metering device, is configured to control a rate at which the second metering device feeds the second bulk material to the first dispensing apparatus to ensure that an accurate amount of the second bulk material is received by the first dispensing apparatus.

With the configuration according to the fourth aspect of the present disclosure, the first bulk material may be a first dry bulk material, and the second bulk material may be either a second dry bulk material or a wet bulk material. Alternatively, the first bulk material may be a first wet bulk material, and the second bulk material may be a second wet bulk material.

According to a fifth aspect of the present disclosure, the bulk material dispensing system may include a housing that is configured to enclose each of the first tank, the first dispensing apparatus, the first conveying system, and the first weigh scale, wherein the controller is mounted to an exterior sidewall of the housing, and an upper panel of the housing serves as the fixed surface.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a first embodiment of a bulk material dispensing system according to a principle of the present disclosure;

FIG. 2 illustrates an example dispensing apparatus that may be used in the bulk material dispensing system illustrated in FIG. 1;

FIG. 3 illustrates another example dispensing apparatus that may be used in the bulk material dispensing system illustrated in FIG. 1;

FIG. 4 illustrates another example dispensing apparatus that may be used in the bulk material dispensing system illustrated in FIG. 1;

FIG. 5 illustrates a second embodiment of a bulk material dispensing system according to a principle of the present disclosure;

FIG. 6 illustrates a third embodiment of a bulk material dispensing system according to a principle of the present disclosure;

FIG. 7 illustrates a fourth embodiment of a bulk material dispensing system according to a principle of the present disclosure;

FIGS. 8A and 8B illustrate a control logic that may be used in any of the bulk material dispensing systems according to the present disclosure;

FIG. 9 schematically illustrates a control system of any of the bulk material dispensing systems according to the present disclosure; and

FIG. 10 illustrates a fifth embodiment of a bulk material dispensing system according to a principle of the present disclosure.

Corresponding reference numerals indicate corresponding parts throughout the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

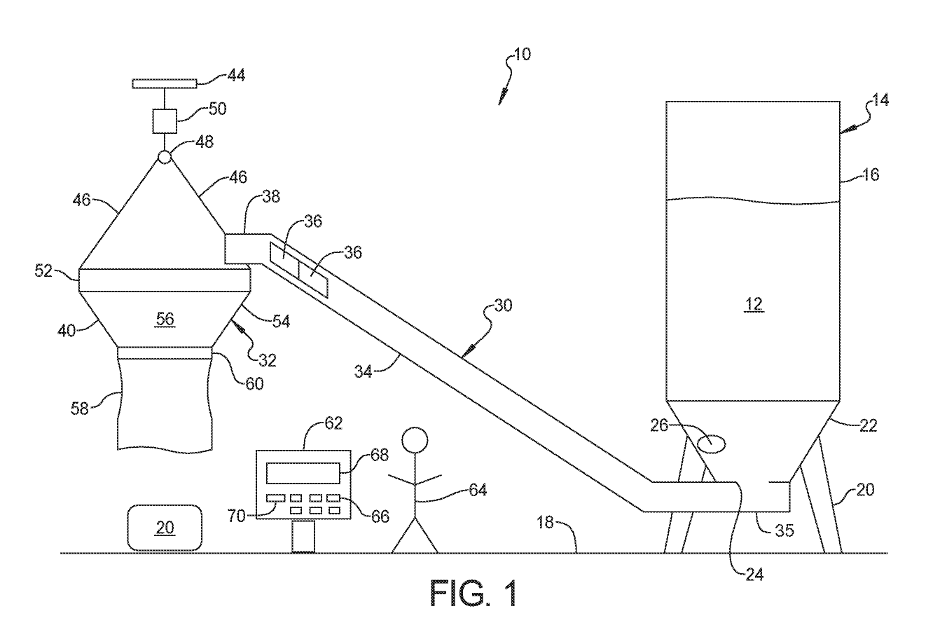

FIG. 1 illustrates a bulk material dispensing system 10 according to a principle of the present disclosure. Bulk material dispensing system 10 is operable to accurately dispense an amount of bulk material 12 that is neither pre-packaged nor pre-measured into a pre-selected quantity. System 10 includes a bulk material storage device or tank 14 that is configured to store the bulk material 12 to be dispensed, therein.

The bulk material 12 held in tank 14 may be either a dry bulk material 12 or a wet bulk material 12. Alternatively, tank 14 may include multiple chambers (not illustrated) therein for holding each of a dry bulk material 12 and a wet bulk material 12 that may be combined as the bulk materials 12 are dispensed. Example dry bulk materials 12 include bird feed, pet food, deer corn, grain, sand, dirt, gravel, chip wood, firewood, food products, grain, salt, mulch, cigarettes, medications, and other dry bulk materials, without limitation. Example wet bulk materials 12 include water, slurry materials, cement, paste products, materials in suspension, and other wet bulk materials, without limitation.

Tank 14 may be formed of a housing 16, which is supported relative to the ground 18 by a support structure 20. Alternatively, housing 16 may be configured to rest on the ground 18 without support structure 20. Housing 16 may be a cylindrical structure, or may be other any shaped structure (e.g., box-shaped) that is configured to store bulk material 12. In the illustrated embodiment, tank 14 is a cylindrically-shaped structure having a truncated portion 22 that assists in funneling bulk material 12 toward an outlet 24 of tank 14.

Tank 14 may include a sensor device 26 therein that is configured to detect a level 28 of bulk material 12 within tank 14. Use of sensor device 26 ensures that there is a sufficient amount of bulk material 12 in tank 14 for dispensing so that the customer is ensured of receiving the desired amount of bulk material 12, when desired. Sensor device 26 may be located at truncated portion 22 of tank 14, or may be located at a different location within tank 14. Sensor device 26 may be configured to detect a mass of the bulk material 12 within tank 14, or may be an optical sensor that is configured to detect the level 28 of bulk material 12 within tank 14. Although only a single sensor device 26 is illustrated, it should be understood that tank 14 may include a plurality of sensor devices 26, if desired, that independently or cooperatively determine the level 28 of bulk material 12 within tank 14.

System 10 also includes a conveying device 30 and a dispensing apparatus 32. Conveying device 30 receives bulk material 12 from outlet 24 of tank 14, and conveys bulk material 12 from outlet 24 to dispensing apparatus 32. Conveying device 30 is preferably detachable from outlet 24, but may be fixed to outlet 24 without departing from the scope of the present disclosure. Conveying device 30 may include a pump (not illustrated) that pumps bulk material 12 from outlet 24 through a conduit 34 to dispensing apparatus 32. Alternatively, conveying device 30 may be one or a combination of a vibratory system, an injection system, an auger system, a conveyor belt system, or any other conveying device known to one skilled in the art. In the illustrated embodiment, conveying device 30 includes conduit 34 having a first end 36 in communication with outlet 24 of tank, and a second end 38 in communication with dispensing apparatus 32.

As bulk material 12 travels through conduit 34 toward dispensing apparatus 32, bulk material 12 will pass through a metering device 36 (shown schematically in FIG. 1) that accurately meters an amount of bulk material 12 allowed to pass therethrough. That is, metering device 36 controls an amount of bulk material 12 that is allowed to exit second end 38 of conduit 34 and enter dispensing apparatus 32.

An example metering device 36 for dry bulk materials 12 is a precision auger that is configured to be controlled with a precise programmed variable rotation control that ensures incremental and precise transfer of discreet amounts of the dry bulk material 12 into the dispensing apparatus 32. In a preferred exemplary embodiment of the present disclosure, as illustrated, the system 10 may have at least two metering devices 36 that are precision augers that are provided in conduit 34 to transfer the dry bulk material 12 simultaneously from the conduit 34 into the dispensing apparatus 32, wherein each of the precision augers are controlled with a precise programmed variable rotation control that ensures incremental and precise transfer of the discreet amount of the bulk material 12 to be distributed into the dispensing apparatus 32. The use of at least two augers as the metering devices 36 is preferable to shorten the time necessary to properly and accurately meter the discreet amounts of the bulk material 12 into the dispensing apparatus 32.

An example metering device 36 for wet bulk materials 12 is a precision pump that is configured to be controlled with a precise programmed variable pumping control that ensures incremental and precise transfer of discreet amounts of the wet bulk material 12 into the dispensing apparatus 32. In a preferred exemplary embodiment of the present disclosure, as illustrated, the system 10 may have at least two metering devices 36 that are precision pumps that are provided within conduit 34 to transfer the wet bulk material 12 simultaneously from the conduit 34 into the dispensing apparatus 32, wherein each of the precision pumps are controlled with a precise programmed variable pumping control that ensures incremental and precise transfer of the discreet amount of the wet bulk material 12 to be distributed into the dispensing apparatus 32. The use of at least two pumps as the metering devices 36 is preferable to shorten the time necessary to properly and accurately meter the discreet amounts of the wet bulk material 12 into the dispensing apparatus 32.

After bulk material 12 is incrementally and precisely metered by metering device 36, bulk material 12 is passed to dispensing apparatus 32. As best shown in FIGS. 1-4, dispensing apparatus 32 includes a receptacle or hopper 40 that is suspended from a fixed surface 44 by a plurality of cables 46. Specifically, cables 46 are connected to a connection plate or ring 48, which in turn is connected to a weigh scale 50 that is suspended from fixed surface 44.

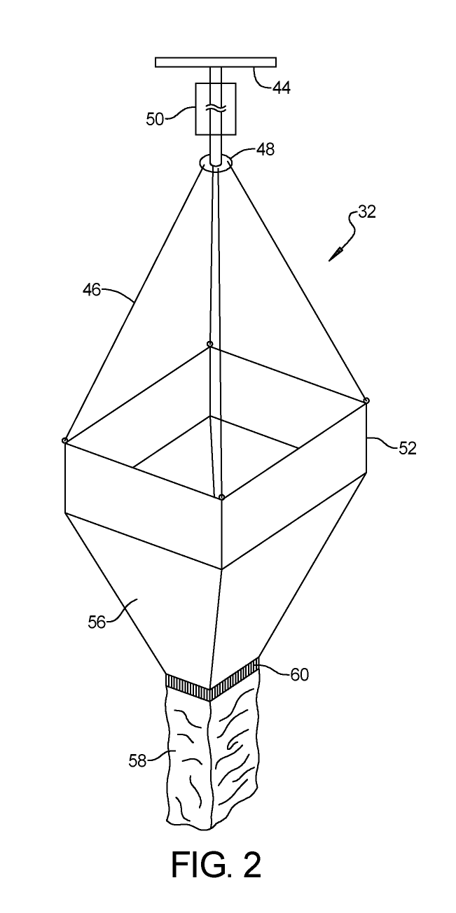

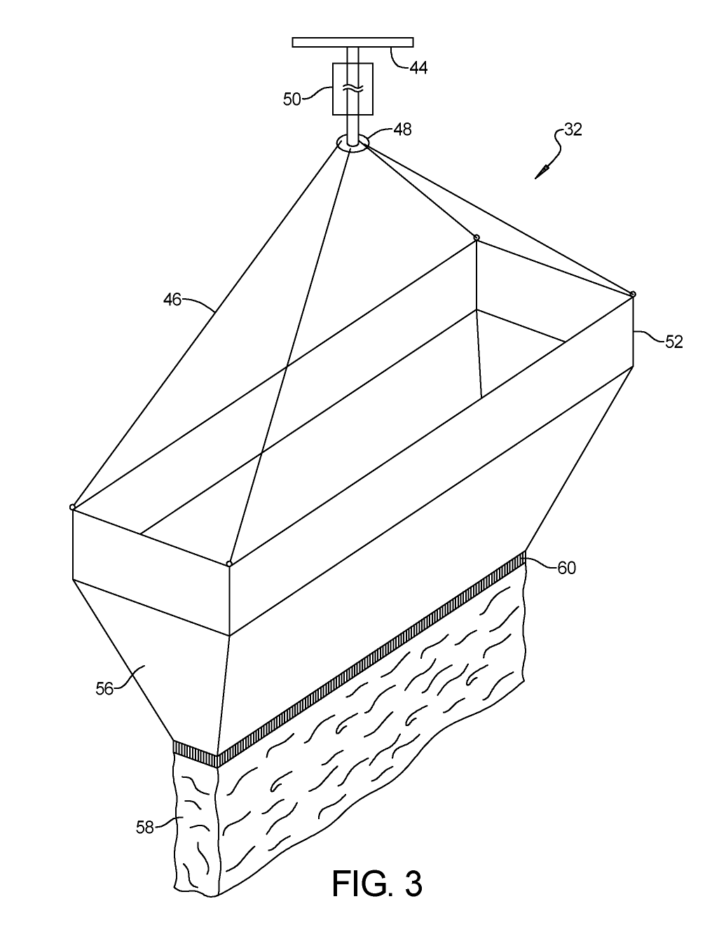

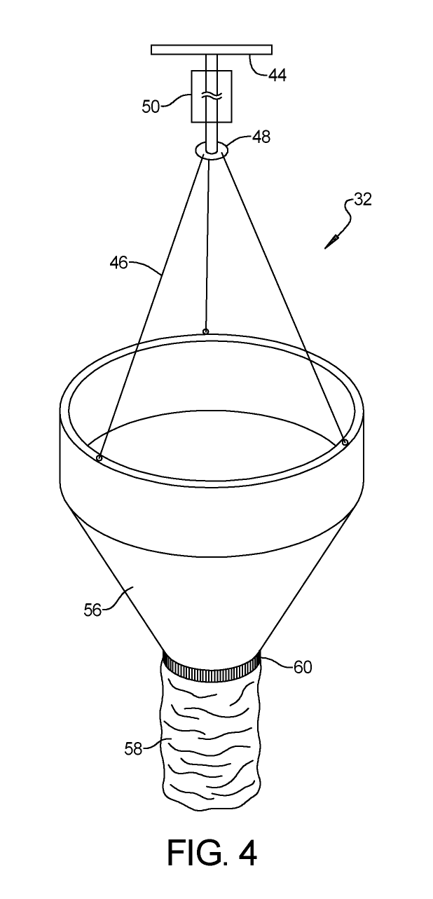

In the illustrated embodiment of FIG. 1, hopper 40 includes upstanding sidewalls 52 that are connected to angularly inwardly extending walls 54 that define a truncated section or funnel 56. Although a square orientation is illustrated for upstanding sidewalls 52, which are connected to fixed surface 44 by four cables 46 (FIGS. 1 and 2), it should be understood that upstanding sidewalls 52 may also be formed to have a rectangular (FIG. 3), circular (FIG. 4), or oval (not illustrated) configuration without departing from the scope of the present disclosure. When a circular or oval configuration is selected, it should be understood that at least three cables 46 should be used to suspend hopper 40 from fixed surface 44.

A chute 58 is connected to funnel 56, with a movable door 60 therebetween. Accordingly, the desired amount of bulk material 12 that is provided to hopper 40 may be stored therein until such time that the consumer is ready for the bulk material 12 to be dispensed. Then, door 60 may be opened either mechanically (i.e., by hand) or automatically to dispense the bulk material 12.

Hopper 40 may be formed of a material such as aluminum, steel, or some other type of metal, or may be formed by materials such as rubber, plastic, wood, composite, or any other material that is suitable for storing and dispensing either wet and/or dry bulk materials 12. Chute 58 may be flexible, or rigid. If chute 58 is rigid, chute 58 may also be formed of the above-noted metal materials, or materials such as rubber, plastic, wood, composite, or any other material that is suitable for storing and dispensing either wet and/or dry bulk materials 12. If chute 58 is designed to be flexible, chute 58 may be formed of rubber, plastic, or a fabric material.

Hopper 40 in combination with metering devices 36 provides a level of weigh accuracy that is not possible with conventional bulk material weigh systems by virtue of the fact hopper 40 is suspended from a single point at fixed surface 44 with at least three cables 46 that may be equally spaced about upstanding walls 52. Cables 46, however, should not be limited to an equally spaced apart configuration depending upon the shape and/or construction of hopper 40.

Conventional weigh chambers or hoppers are typically supported by the ground 18 rather than suspended, which is a reason that conventional weigh chambers cannot provide incremental and accurate metering of bulk material 12 in comparison to hopper 40 that is a suspended from a single point at fixed surface 44. This is a primary reason why there are currently no conventional delivery systems for bulk materials that utilize a weigh chamber or hopper that is supported by the ground 18 that are certified by the Federal Government Department of Agriculture through the National Institute of Standards and Technology (NIST).

In this regard, conventional weigh chambers that are suspended from a single point do not utilize a precision delivery system such as metering device 36 for distributing bulk material 12 into the weigh chamber, nor multiple precision delivery systems like the use of multiple metering devices 36 for the delivery of bulk materials into the weigh chamber. Further, there are no known conventional weigh chambers that can receive both wet and dry bulk materials to be dispensed at the same time.

The system 10 illustrated in FIG. 1 has been independently tested using traceable standards and verified by the National Type Evaluation Program (NTEP), which is a non-profit organization within the National Conference on Weights and Measures (NCWM). One function of NTEP is to conduct evaluations of weigh scale systems to ensure compliance with standards of the Federal Government Department of Agriculture through NIST. At the time of this application, the system 10 of the present disclosure has the distinction of being granted the status of the first and only current bulk material dispensing system recognized as “Legal for Trade” in the USA (i.e., NTEP compliant)

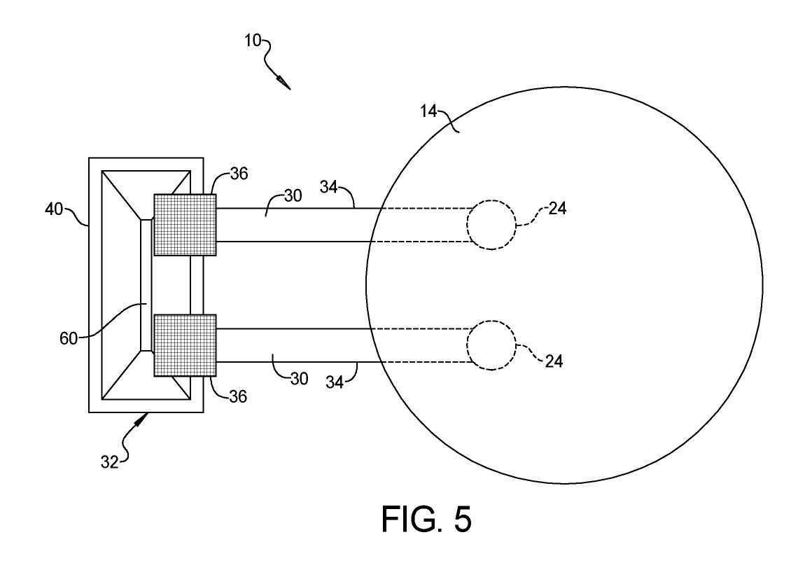

Now referring to FIG. 5, it can be seen that bulk material dispensing system 10 can include a pair of conveying devices 30. When system 10 includes a pair of conveying devices 30, tank 14 includes a pair of outlets 24. Tank 14 may also include a pair of truncated portions 22 that each include an outlet 24. Similar to the embodiment illustrated in FIG. 1, each outlet 24 is configured to communicate with a respective conduit 34 of a respective conveying device 30. Each conveying device 30 may include a pump (not illustrated) that pumps bulk material 12 from a respective outlet 24 through a respective conduit 34 to dispensing apparatus 32. Alternatively, conveying devices 30 may be one or a combination of a vibratory system, an injection system, an auger system, a conveyor belt system, or any other conveying device known to one skilled in the art. In the illustrated embodiment, dispensing apparatus 32 is the rectangular dispensing apparatus 32 illustrated in FIG. 3. Due to the elongated structure of the rectangular dispensing apparatus 32, dispensing apparatus 32 is better configured for receipt of bulk material 12 from a pair of conveying devices 30. It should be understood, however, that any of the dispensing apparatuses 32 can receive bulk material 12 from a pair of conveying devices 30, without departing from the scope of the present disclosure.

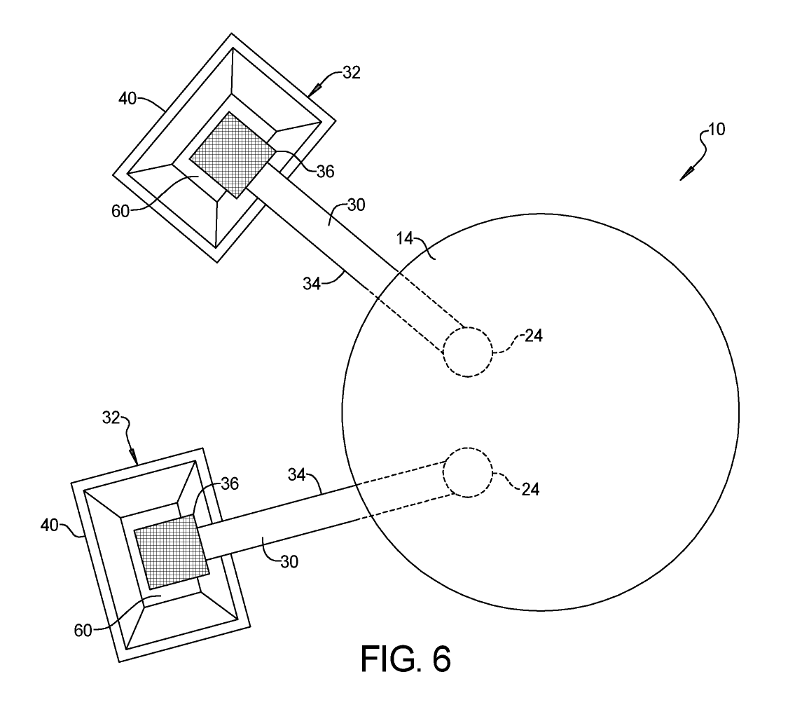

Now referring to FIG. 6, it can be seen that bulk material dispensing system 10 can include a pair of conveying devices 30. Similar to the embodiment of FIG. 5, when system 10 includes a pair of conveying devices 30, tank 14 includes a pair of outlets 24. Tank 14 may also include a pair of truncated portions 22 that each include an outlet 24. Each outlet 24 is configured to communicate with a respective conduit 34 of a respective conveying device 30. Each conveying device 30 may include a pump (not illustrated) that pumps bulk material 12 from a respective outlet 24 through a respective conduit 34 to dispensing apparatus 32. Alternatively, conveying devices 30 may be one or a combination of a vibratory system, an injection system, an auger system, a conveyor belt system, or any other conveying device known to one skilled in the art.

The difference between the embodiments in FIG. 5 and FIG. 6 is that the embodiment illustrated in FIG. 6 includes separate dispensing apparatuses 32 that communicate with a respective conveying device 30. Any of the dispensing apparatuses 32 illustrated in FIGS. 2-4 can be used, without limitation.

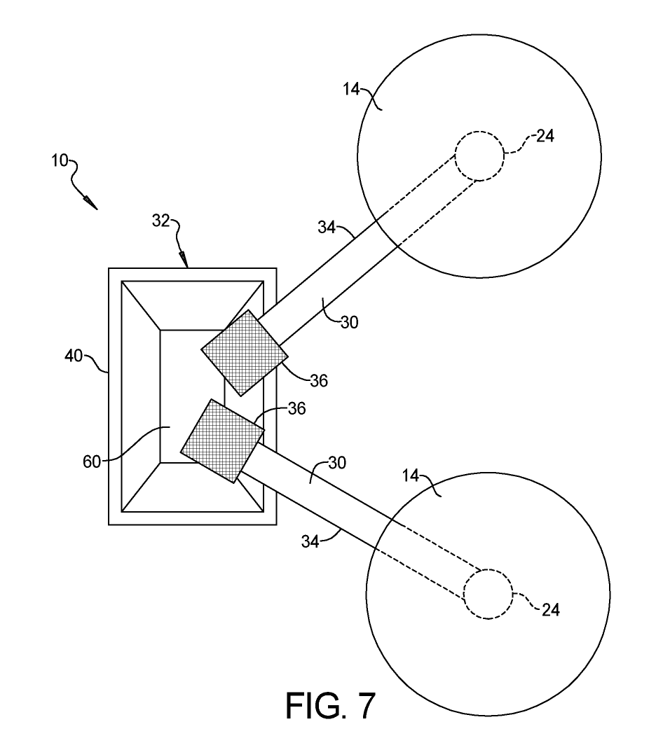

Now referring to FIG. 7, it can be seen that bulk material dispensing system 10 can be modified to include a pair of tanks 14 that each communicate with a respective conveying device 30, and the pair of conveying devices 30 each communicate with a single dispensing apparatus 32. The tanks 14 and conveying devices 30 illustrated in FIG. 7 can be the same as those illustrated in FIG. 1, while dispensing apparatus 32 can be any of the dispensing apparatuses illustrated in FIGS. 2-4. Alternatively, conveying devices 30 may be one or a combination of a vibratory system, an injection system, an auger system, a conveyor belt system, or any other conveying device known to one skilled in the art.

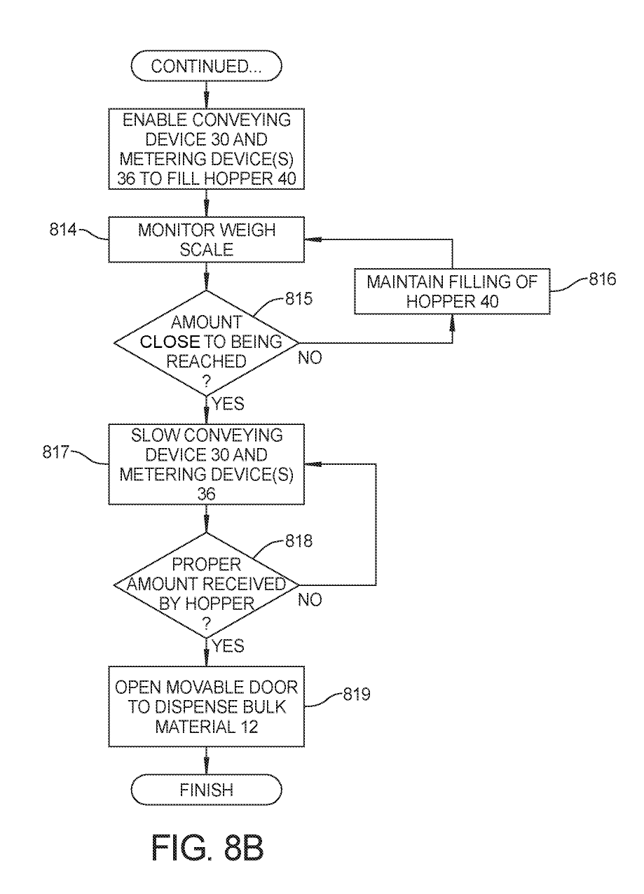

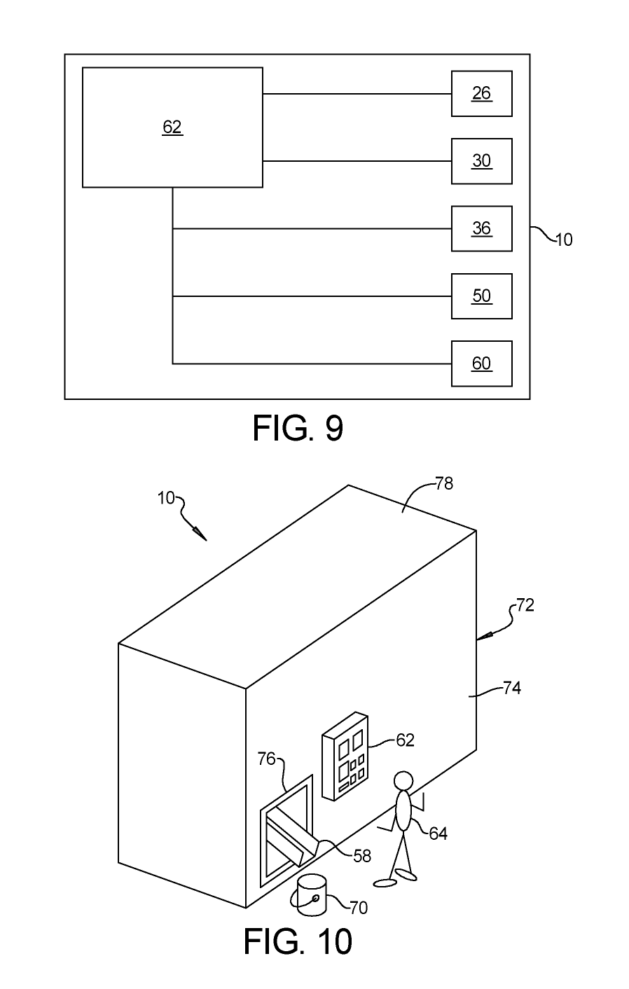

As shown in FIGS. 1 and 10, bulk material dispensing system 10 includes a kiosk or control terminal 62 that may be accessed by a user 64 to control operation of bulk material dispensing system 10. Control terminal 62 can be an electronic control unit (ECU) that includes various control circuitry (not shown) that is electrically or wirelessly connected to various elements of bulk material dispensing system 10. For example, as shown in FIG. 9, control terminal 62 is configured to communicate with sensor device 26, conveying system 30, metering device(s) 36, weigh scale 50, and movable door 60 to control dispensing of bulk material 12 from tank 14. As illustrated in FIG. 1, control terminal 62 includes various control buttons 66 (e.g., on, start, stop, pre-programmed amounts of bulk material to be dispensed, etc.) that may be accessed by user 64 to control bulk material dispensing system 10. In addition, control terminal 62 may include a display 68 for displaying various messages (e.g., error messages, and various prompts) and a reader/receptacle 70 for insertion of paper money and/or a credit card to purchase bulk material 12.

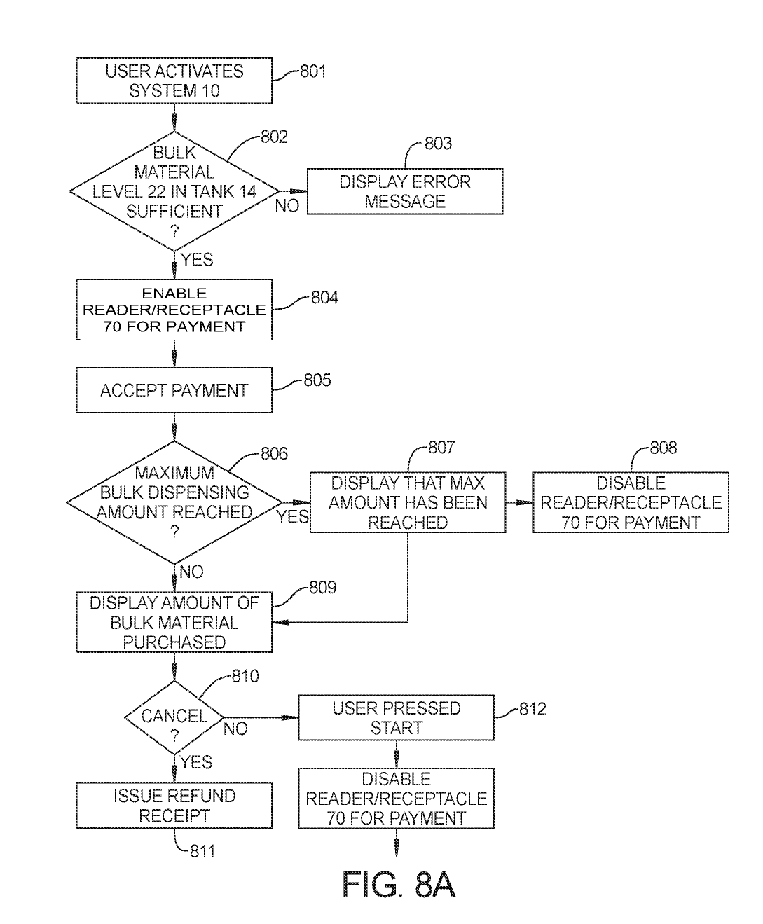

An example control logic that is stored in control terminal 62 is illustrated in FIGS. 8A and 8B. At step 801, the user 64 activates bulk material dispensing system 10 by pressing, for example, a button 66 that powers system 10 to an active state. Alternatively, if system 10 is already active, user 64 may simply press a button 66 that indicates the beginning of a new transaction. After system 10 is powered on or when a new transaction has begun, control terminal 62 at step 802 communicates with sensor device 26 to determine whether the bulk material level 28 in tank 14 is sufficient for dispensing bulk material 12 therefrom. In other words, control terminal 62 communicates with sensor device 26 to determine whether there is a sufficient amount of bulk material 12 for purchase. If not (step 803), display 68 of control terminal 62 will display an error message indicating that a sufficient amount of bulk material 12 is not present for purchase.

If there is a sufficient amount of bulk material 12 present in tank 14 for purchase, control terminal 62 will enable reader/receptacle 70 for either receipt of paper money or for receipt of a credit card for payment (step 804), and accept payment (step 805). Depending on the amount of payment that is received, control terminal 62 will then determine at step 806 whether the maximum amount of bulk material 12 has been purchased (i.e., the maximum amount that is available in tank 14, or the maximum amount that can be held by hopper 40). If yes, display 68 will display a message that the maximum amount for purchase has been reached (step 807) and disable the reader/receptacle 70 so that no additional payment can be accepted (step 808). If no, the display 68 will display a message that indicates the amount of bulk material 12 that has been purchased (e.g., 100 pounds) (step 809). At this time, the user 64 can decide whether to proceed with the transaction at step 810. If the user 64 would like to cancel the transaction, control terminal 62 will issue a refund receipt and any cash that was received (step 811). If user 64 would like to continue with the transaction, user 64 may press a button 66 that will start the process for dispensing the bulk material (step 812), and disable the reader/receptacle 70 from receiving any further payment.

At this time, each of the conveying device 30 and metering device(s) 36 are activated to begin conveying bulk material 12 from tank 14 to hopper 40 (step 813). As bulk material 12 is fed to hopper 40, control terminal 62 communicates with weigh scale 50 to monitor the amount of bulk material 12 received by hopper 40 (step 814). In this regard, each of conveying device 30 and metering device(s) 36 can also be instructed by control terminal 62 to operate at an increased rate to quicken the dispensing process. As the amount of bulk material 12 received by hopper 40 approaches the purchased amount (e.g., the amount received by hopper 40 is within 10 pounds of the purchased amount), it can be determined (step 815) whether to continue operating conveying device 30 and metering device(s) 36 at the increased rate (step 816), or whether conveying device 30 and metering device(s) 36 should be controlled to operate at a reduced rate (step 817) that allows for only the correct purchased amount to be received by hopper 40 (step 818). As noted above, the metering device(s) 36 used for dispensing bulk materials 12 may be precision augers or precision pumps that are configured to be controlled with a precise programmed variable rotation control or pumping control that ensures incremental and precise transfer of discreet amounts of the bulk material 12 into the hopper 40. Thus, by precisely controlling the variable rotation or pumping control of the metering device 36, the correct purchased amount can be received by hopper 40 at tolerances of +/−0.01%.

Once it has been determined that the proper amount of bulk material 12 has been received by hopper 40 (step 818), control terminal 62 will halt conveying device 30 and metering device(s) 36, and open the movable door 60 to dispense the purchased amount of bulk material 12 (step 819) into the user's desired receptacle 70. After door 60 has been opened to dispense bulk material 12, control terminal 62 can either be powered off or go into a standby mode that awaits another transaction. Alternatively, control terminal 62 can issue a receipt that indicates the dispensed amount of bulk material and its corresponding purchase price.

It should be understood that the above-noted control logic can modified, as necessary or desired. For example, if the amount of bulk material 12 received by hopper 40 is less than the purchased amount due to some type of error, control terminal 62 can issue a refund receipt. Another possible step includes a step of ensuring that movable door 60 is closed when a new transaction is initiated, or conducting a system diagnostic check to determine, for example, whether conveying device 30 and metering device(s) 36 are operating correctly. Other processing steps are possible, without limitation.

It should also be understood that bulk material dispensing system 10 can include more than one control terminal 62 so that multiple users 64 can make purchases simultaneously. Indeed, the bulk material dispensing system 10 illustrated in FIG. 6 that has two hoppers 40 that each independently receive bulk material 12 from tank 14 can be operated simultaneously, by different users 64 without departing from the scope of the present disclosure.

Moreover, it should be understood that control terminal 62 can be used to dispense both dry and wet bulk materials 12. For example, again referring to FIG. 7 where bulk material dispensing system 10 includes a pair of tanks 14 that each communicate with the same hopper 40, one of the tanks 14 may include a wet bulk material (e.g., water, liquid fertilizer, etc.) and the other tank 14 may include a dry bulk material (e.g., soil, dry fertilizer, grain, etc.). If such a system 10 is used, control terminal 62 can allow user 64 to select different amounts of each material 12 to be received by hopper 40. For example, if user 64 desired, for example, an 80:20 blend of water to dry fertilizer, user 64 would be able to use control terminal 62 to control the amounts of each constituent that are dispensed from each tank 14. Although an 80:20 blend is described above, it should be understood that any ratio of materials can be selected, without limitation. It should also be understood that each tank 14 can hold dry bulk materials 12, or each tank can hold wet bulk materials 12. For example, if tanks 14 each held a dry bulk material 12 such as birdseed, the ratio of one bird seed to another could be selected by user, without limitation.

Lastly, referring to FIG. 10, it should be understood that bulk delivery system 10 may be enclosed in an enclosure or housing 72. Housing 72 includes control terminal 62 affixed to a sidewall 74, and encloses various features (not illustrated) of bulk material delivery system 10 such as tank 14, conveying device 30, dispensing device 32, and weigh scale 50. In the illustrated embodiment, housing 72 includes an opening 76 upon which an end of chute 58 may be seen. Although not shown in FIG. 10, it should be understood that dispensing device 32 includes a hopper 40 suspended by cables 46 to a plate or ring 48, which in turn is connected to weight scale 50, which in turn is connected to upper panel 78 of housing 72 in a manner similar to FIG. 1. Such a configuration is beneficial for dispensing smaller quantities of bulk materials 12 such as bird seed, pet food, bait materials, fertilizer, rock salt, and other bulk materials that are typically sold in smaller quantities (e.g., in amounts less than 20 pounds).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A bulk material dispensing system, comprising:
a first tank configured to carry a first bulk material;
a first dispensing apparatus suspended from a fixed surface, and configured to receive the first bulk material from the first tank and dispense the first bulk material;
a first conveying system positioned between the first tank and the first dispensing apparatus, and including a first metering device for feeding the first bulk material from the first tank to the first dispensing apparatus;
a first weigh scale located between the first dispensing apparatus and the fixed surface, and configured to communicate a signal indicative of an amount of the first bulk material that has been fed to the first dispensing apparatus by the first metering device; and
a controller in communication with each of the first weigh scale and the first metering device, and based on the signal indicative of the amount of the first bulk material that has been fed to the first dispensing apparatus by the first metering device, is configured to control a rate at which the first metering device feeds the first bulk material to the first dispensing apparatus to ensure that an accurate amount of the first bulk material is received by the first dispensing apparatus.

2. The system according to claim 1, wherein the first tank includes a sensor in communication with the controller, and the sensor is configured to communicate a signal indicative of an amount of the first bulk material present in the first tank.

3. The system according to claim 1, wherein the first dispensing apparatus includes a hopper suspended by a plurality of cables from the fixed surface.

4. The system according to claim 3, wherein each of the cables are attached to the fixed surface at a single location.

5. The system according to claim 3, wherein the hopper includes a movable door that is manually actuatable, or is in communication with the controller such that when the hopper has received the accurate amount of the first bulk material, the controller actuates the movable door to an open position to dispense the first bulk material.

6. The system according to claim 3, wherein the hopper includes a chute for dispensing the first bulk material.

7. The system according to claim 1, wherein the first conveying system includes one or a combination of a vibratory system, an injection system, and a conveyor belt system.

8. The system according to claim 1, wherein the first metering device includes precision auger having a precise programmed variable rotation control that is controlled by the controller to control the rate at which the metering device feeds the first bulk material to the first dispensing apparatus.

9. The system according to claim 8, wherein the first bulk material is a dry bulk material.

10. The system according to claim 1, wherein the first metering device is a precision pump having a precise programmed variable pumping control that is controlled by the controller to control the rate at which the first metering device feeds the first bulk material to the first dispensing apparatus.

11. The system according to claim 10, wherein the first bulk material is a wet bulk material.

12. The system according to claim 1, further comprising a second conveying system positioned between the first tank and the first dispensing apparatus, and including a second metering device for feeding the first bulk material from the first tank to the first dispensing apparatus,
wherein the controller is in communication with the second metering device, and based on the signal indicative of the amount of the first bulk material that has been fed to the first dispensing apparatus by the first metering device and the second metering device, is configured to control a rate at which the first metering device and the second metering device feeds the first bulk material to the first dispensing apparatus to ensure that an accurate amount of the first bulk material is received by the first dispensing apparatus.

13. The system according to claim 1, further comprising:
a second dispensing apparatus suspended from the fixed surface, and configured to receive the first bulk material from the first tank and dispense the first bulk material;
a second a conveying system positioned between the first tank and the second dispensing apparatus, and including a second metering device for feeding the first bulk material from the first tank to the second dispensing apparatus; and
a second weigh scale located between the second dispensing apparatus and the fixed surface, and configured to communicate a signal indicative of an amount of the first bulk material that has been fed to the second dispensing apparatus by the second metering device,
wherein the controller is in communication with each of the second weigh scale and the second metering device, and based on the signal indicative of the amount of the first bulk material that has been fed to the second dispensing apparatus by the second metering device, is configured to control a rate at which the second metering device feeds the first bulk material to the second dispensing apparatus to ensure that an accurate amount of the first bulk material is received by the second dispensing apparatus.

14. The system according to claim 1, further comprising:
a second tank configured to carry a second bulk material; and
a second conveying system positioned between the second tank and the first dispensing apparatus, and including a second metering device for feeding the second bulk material from the second tank to the first dispensing apparatus;
wherein the first weigh scale is configured to communicate a signal indicative of a combined amount of the first bulk material and the second bulk material that has been fed to the first dispensing apparatus by the first and second metering devices; and
the controller is in communication with each of the first weigh scale and the second metering device, and based on the signal indicative of the combined amount of the second bulk material that has been fed to the first dispensing apparatus by the second metering device, is configured to control a rate at which the second metering device feeds the second bulk material to the first dispensing apparatus to ensure that an accurate amount of the second bulk material is received by the first dispensing apparatus.

15. The system according to claim 14, wherein the first bulk material is a first dry bulk material, and the second bulk material is either a second dry bulk material or a wet bulk material.

16. The system according to claim 14, wherein the first bulk material is a first wet bulk material, and the second bulk material is a second wet bulk material.

17. The system according to claim 1, further comprising a housing that is configured to enclose each of the first tank, the first dispensing apparatus, the first conveying system, and the first weigh scale,
wherein the controller is mounted to an exterior sidewall of the housing, and an upper panel of the housing serves as the fixed surface.
